(19) United States
(12) Patent Application Publication
(10) Pub. No.: US 2007/0188450 A1
(43) Pub. Date: Aug. 16, 2007

(54) Method and system for a reversible display interface mechanism

(75) Inventors: Manuel Hernandez, Gilroy, CA (US); Anthony Edward Martinez, St. Augustine, FL (US)

Correspondence Address: DUKE W. YEE, YEE AND ASSOCIATES, P.C., P.O. BOX 802333, DALLAS, TX, 75380, US

(73) Assignee: International Business Machines Corporation, Armonk, NY (US)

(21) Appl. No.: 11/353,747

(22) Filed: Feb. 14, 2006

(51) Int. Cl. G09G 5/08

(52) U.S. Cl. 345/158

(57) ABSTRACT

A system for displaying data in a portable data processing system with a plurality of display interfaces. Data is displayed within a first display interface of the portable data processing system. A user input, which is a change in orientation of the portable data processing system, is detected. After determining a type of change in orientation of the portable data processing system, data is displayed within the first display interface or a second display interface of the portable data processing system based upon the type of change in orientation.

### BACKGROUND OF THE INVENTION

1. Field of the Invention

The present invention relates generally to an improved data processing system. More specifically, the present invention is directed to a computer implemented method, data processing system, and computer useable program code for displaying data in a portable data processing system with a plurality of display interfaces.

2. Description of the Related Art

As advances in technology continue to further enable miniaturization of computer system components, new categories of data processing systems have been created. One of these new categories of data processing systems is the portable or handheld computer system. Examples of portable data processing systems are personal digital assistants, electronic address books, electronic day planners, electronic schedulers, video game systems, laptop computers, palmtop computers, and the like.

A handheld data processing system is a computer that is small enough to be held in the user's hand. As a result, handheld data processing systems are readily carried in a user's briefcase, purse, or pocket. By virtue of their size, handheld data processing systems are exceptionally lightweight, portable and convenient.

These handheld data processing systems, and others like them, have in common some type of screen for displaying data as part of a user interface. Many different kinds of display interfaces may be used, such as, for example, liquid crystal displays and gas discharge displays. Display interfaces presently come in many shapes and sizes and are adapted for use in multiple environments. For example, handheld computers may use a screen to display computer generated information such as text and graphics.

In the case of a personal digital assistant, and similar devices, the display interface is typically a touch screen able to register contact between the screen and the tip of a stylus. The user may input commands and move between applications by touching the stylus to various parts of the screen or to virtual buttons rendered on the screen. Personal digital assistants, and other such handheld devices, also may have built-in or programmable buttons that may be used to implement various functions and to navigate among and within different applications.

Also, the handheld data processing system may utilize function buttons in an attempt to provide viewing of data in a multiple page format. For example, to advance to the next page of the multi-page document, a user may depress an up button and to revert back to the previous page, a user may depress a down button. While this utilization of function buttons provides a way to view data in a multiple page format that is acceptable to many, users may desire a more natural way to advance to a different page of screen display information.

Consequently, there are many well-known mechanisms used to provide a user interface for handheld and portable computer systems, which may include laptop computers. These well-known mechanisms tend to work well with the different types of display interfaces currently in use. However, applying well-known user interface mechanisms to portable handheld devices does not take advantage of the user's capability to control and manipulate such devices with a single hand. In addition, known display interfaces are growing in functionality and complexity in an ever-decreasing screen “real estate.” The result of this increased functionality and complexity in an ever-decreasing screen real estate is a suboptimized user experience through densely packed interfaces, nested windows, and long paths to complete a task. These non-intuitive, intimidating interfaces take a long time to master.

Therefore, it would be beneficial to have a computer implemented method, data processing system, and computer usable program code for providing a user-friendly interface that more fully utilizes the advantages afforded by the portability of handheld devices.

### SUMMARY OF THE INVENTION

The present invention provides a computer implemented method, data processing system, and computer useable program code for displaying data in a portable data processing system with a plurality of display interfaces. Data is displayed within a first display interface of the portable data processing system. Subsequent to displaying data within the first display interface, a user input is detected. The user input is a change in orientation of the portable data processing system. After determining a type of change in orientation of the portable data processing system, data is displayed within the first display interface or a second display interface of the portable data processing system based upon the type of change in orientation.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a personal digital assistant in which aspects of the present invention may be implemented;

FIG. 2 is a block diagram of a personal digital assistant in which aspects of the present invention may be implemented;

FIG. 3 is a pictorial representation of a portable data processing system which depicts a display interface on the front and back of the device in accordance with an illustrative embodiment of the present invention;

FIG. 4A is a side view of a portable data processing system containing a single reversible liquid crystal display panel in accordance with an illustrative embodiment of the present invention;

FIG. 4B is a side view of a portable data processing system containing two back-to-back liquid crystal display panels in accordance with an illustrative embodiment of the present invention;

FIG. 5 is an exemplary illustration of a portable data processing system displaying an active time clock application in accordance with an illustrative embodiment of the present invention;

FIG. 6 is an exemplary illustration of a portable data processing system displaying a record album cover or compact disc case graphic in accordance with an illustrative embodiment of the present invention;

FIG. 7 is an exemplary illustration of a portable data processing system displaying an electronic book in accordance with an illustrative embodiment of the present invention;

FIG. 8 is a flowchart illustrating an exemplary process for displaying a time application within a portable data processing system with a plurality of display interfaces in accordance with an illustrative embodiment of the present invention; and

FIG. 9 is a flowchart illustrating an exemplary process for displaying an electronic book application within a portable data processing system with a plurality of display interfaces in accordance with an illustrative embodiment of the present invention.

### DETAILED DESCRIPTION OF THE PREFERRED EMBODIMENT

With reference now to the figures, FIG. 1 depicts a pictorial representation of a personal digital assistant (PDA) in which aspects of the present invention may be implemented. However, FIG. 1 is only exemplary and not intended to assert or imply any limitation with regard to the environments in which aspects or embodiments of the present invention may be implemented. Those of ordinary skill in the art will appreciate that any type of portable data processing system, which includes a display interface, may utilize embodiments of the present invention. For example, in addition to a PDA, embodiments of the present invention may be implemented in a digital music player, laptop computer, cellular telephone, palmtop computer, video game system, digital camera, and the like.

PDA 100 includes display 102 for presenting textual and graphical information. Display 102 may be a known display device, such as, for example, a liquid crystal display (LCD) device. However, any display device that may be implemented by embodiments of the present invention may be utilized, such as a plasma display device.

Display 102 may be used, for example, to present a map, driving directions, calendar information, telephone numbers, electronic mail messages, a clock, music selections, books, documents, et cetera. In addition, display 102 may be a touch screen that receives user input from an input device, such as stylus 104. Stylus 104 may be used to tap icons and menu selections within an active application. Further, display 102 may include an on-screen keyboard, which may be tapped by stylus 104 to input information.

Furthermore, PDA 100 includes a second display interface, not shown in this FIG. 1 illustration, on the backside of PDA 100. The second display interface on the backside of PDA 100 may be the same size or a different size display interface as display 102. In addition, embodiments of the present invention are not restricted to the use of only two display interfaces. A plurality of display interfaces may be implemented by embodiments of the present invention. For example, a portable data processing system with a triangular configuration may utilize three display interfaces or a portable data processing system with a square configuration may utilize four display interfaces.

PDA 100 also may include, for example, a keypad and speaker, such as keypad 106 and speaker 108. PDA 100 may utilize keypad 106 to receive user input in addition to utilizing stylus 104 on display 102. Speaker 108 provides a mechanism for audio output, such as presentation of an audio file, on PDA 100.

PDA 100 also preferably includes a graphical user interface that may be implemented by means of systems software residing in computer usable program code in operation within PDA 100. FIG. 1 is intended as an example, and not as an architectural limitation for different embodiments of the present invention.

Aspects of the present invention provide a computer implemented method, apparatus, and computer useable program code for displaying data in a portable data processing system with a plurality of display interfaces. A user inputs a user input to open an application within the portable data processing system. After receiving the user input to open the application, the portable data processing system displays data within a first display interface of the portable data processing system. The data displayed within the first display interface may be, for example, text, graphics, pictures, images, icons, or any combination thereof.

Subsequent to displaying the data, the portable data processing system may detect a user input, which is a change in orientation of the portable data processing system. The change in orientation may be, for example, a flip or tilt of the portable data processing system. The portable data processing system may use, for example, a gyroscope to detect and determine the type of change in orientation. Based upon the type of change in orientation, the portable data processing system may display the same or different data within the first display interface or a second display interface of the portable data processing system. Further, the portable data processing system may perform a task, such as a navigation function, within the active application based upon the type of change in orientation.

Aspects of embodiments of the present invention simplify user interaction with a portable data processing system by removal of application controls. Thus, a user is not required to manually input the application controls. As a result, the number of steps to accomplish an application task may be reduced, thereby increasing user friendliness of the portable data processing system. In addition, embodiments of the present invention effectively increase the amount of display interface “real estate” available to the user, thus increasing user satisfaction of the portable data processing system.

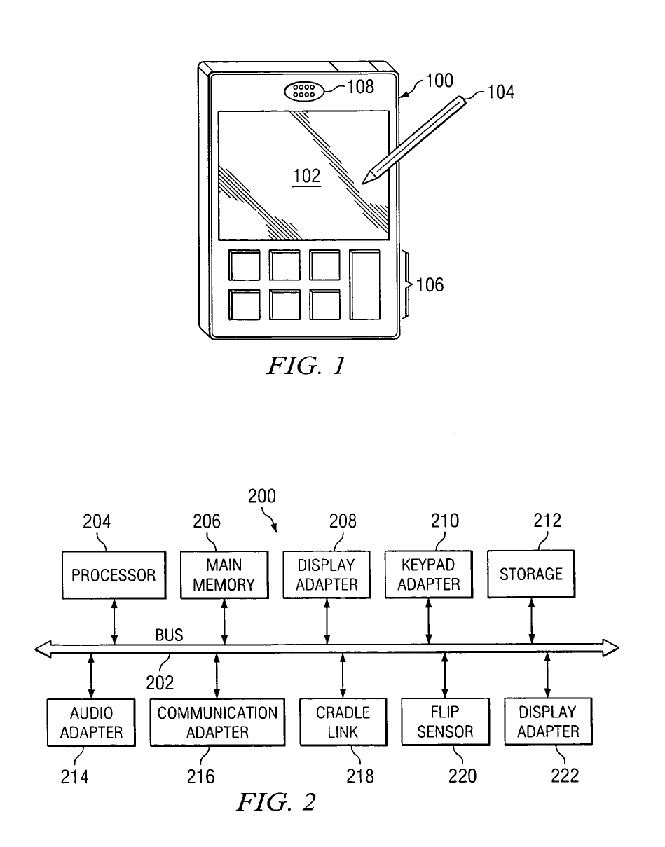

Referring now to FIG. 2, a block diagram of a PDA is shown in which aspects of the present invention may be implemented. PDA 200 is an example of a portable data processing system, such as PDA 100 in FIG. 1, in which computer usable code or instructions implementing the processes for embodiments of the present invention may be located.

PDA 200 includes bus 202 to which processor 204 and main memory 206 are connected. Of course, bus 202 may be implemented using any type of communication fabric or architecture that provides for a transfer of data between different components or devices attached to the fabric or architecture. Display adapter 208, keypad adapter 210, storage 212, audio adapter 214, communication unit 216, and cradle link 218 also are connected to bus 202.

An operating system runs on processor 204 and is used to coordinate and provide control of various components within PDA 200. The operating system may be, for example, a commercially available operating system such as Windows® CE, which is available from Microsoft® Corporation. Instructions for the operating system and applications or programs are located on storage devices, such as storage 212, and may be loaded into main memory 206 for execution by processor 204.

Display adapter 208 is used to control display of data within a display interface, such as display 102 in FIG. 1. Display adapter 208 also may include a mechanism to receive user input from a stylus, such as stylus 104 in FIG. 1, when a touch screen display interface is employed. Communication adapter 216 provides a mechanism for establishing a wireless communication link between PDA 200 and a network or cellular telephone, for example. Communication adapter 216 may employ an internal antenna within PDA 200 to facilitate establishment of the wireless communication link. Cradle link 218 provides a mechanism to connect PDA 200 to a cradle used for synchronizing data contained within PDA 200 with another data processing system, such as, for example, a personal computer.

Further, PDA 200 also may include flip sensor 220, which is connected to bus 202 as well. Flip sensor 220 may be, for example, a chip-sized gyroscope or mercury switches. PDA 200 utilizes flip sensor 220 to detect spatial orientation of PDA 200. In other words, PDA 200 uses flip sensor 220 to detect position, degree of pitch or tilt, motion, speed of motion, and direction of motion of PDA 200.

With regard to position, PDA 200 uses flip sensor 220 to detect which side of PDA 200 is face up. With regard to degree of pitch or tilt, PDA 200 uses flip sensor 220 to detect the angle at which PDA 200 is oriented, such as, for example, at 0, 45, or 90 degrees relative to a horizontal relationship with the ground. With regard to motion, PDA 200 uses flip sensor 220 to detect, for example, when a user flips or tilts PDA 200. With regard to speed of motion, flip sensor 220 may utilize a mechanism, such as, for example, an accelerometer, to determine the speed of the flip or tilt performed by the user on PDA 200. Finally, with regard to direction of motion, PDA 200 uses flip sensor 220 to determine the direction of the flip or tilt, such as clockwise or counterclockwise.

In another embodiment of the present invention, PDA 200 may include one or more additional display adapters, such as display adapter 222. PDA 200 may use display adapter 222 to control the display of data on a second display interface positioned on the backside of the PDA. Embodiments of the present invention that utilize a plurality of display interfaces may use one display adapter for each display interface. Alternatively, one display adapter, such as display adapter 208, may be used to display data in all display interfaces or only a portion of the plurality of display interfaces.

PDA 200 may display data in each of the plurality of display interfaces one at a time or in all display interfaces simultaneously. In addition, PDA 200 may display the same image or different data simultaneously within the plurality of display interfaces. Further, PDA 200 may display a different image in a different display interface in response to a predetermined user input. The predetermined user input may be, for example, a quick clockwise flipping motion of the PDA. The quick clockwise flipping motion may cause, for example, an active application within the PDA to go from displaying the last page of a multi-page document on one display interface to displaying the first page of the multi-page document on a different display interface. However, embodiments of the present invention are not restricted to the use of a clockwise flipping motion as a user input. Any direction and speed of motion may be implemented as a user input by embodiments of the present invention.

Those of ordinary skill in the art will appreciate that the hardware in FIG. 2 may vary depending on the implementation. Other internal hardware or peripheral devices, such as flash ROM, equivalent nonvolatile memory, or optical disk drives and the like, may be used in addition to or in place of the hardware depicted in FIG. 2. The flash memory may be used to provide nonvolatile memory for storing operating system files and/or user-generated data.

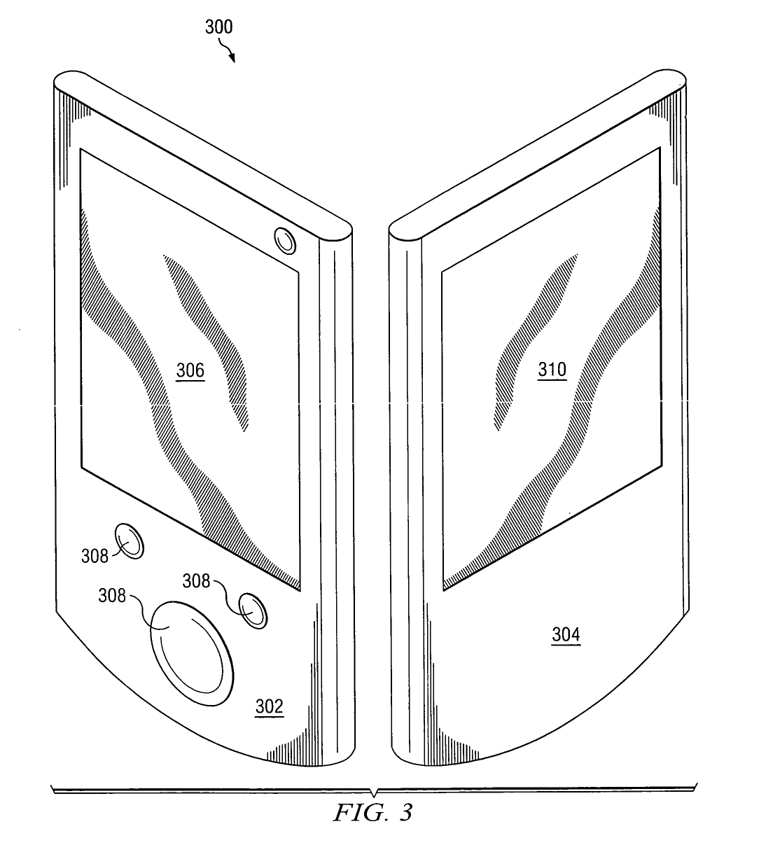

Turning now to FIG. 3, a pictorial representation of a portable data processing system is shown which depicts a display interface on the front and back of the device in accordance with an embodiment of the present invention. Portable data processing system 300 may be, for example, PDA 100 in FIG. 1. However, in addition to a PDA, portable data processing system 300 may be any portable data processing system, such as, for example, a video game system, digital music player, cellular telephone, or palmtop computer.

Portable data processing system 300 contains front side 302 and backside 304. Front side 302 includes display interface 306, such as display 102 in FIG. 1, and function buttons 308. Display interface 306 may be, for example, a liquid crystal display. Moreover, display interface 306 may be equipped with touch screen capabilities.

Function buttons 308 may be, for example, a forward arrow button on the right side, a multi-purpose button in the center, and a backward arrow button on the left side. However, embodiments of the present invention are limited to the above listed function buttons. Function buttons 308 may consist of more or less buttons with the same or different functions available to the user. Also, embodiments of the present invention may not utilize any function buttons on portable data processing system 300.

Backside 304 includes display interface 310. Display interface 310 also may be, for example, a liquid crystal display with touch screen capabilities. Also, display interface 310 may be integrally related to display interface 306. For example, display interfaces 306 and 310 may be two opposite sides of a two-sided liquid crystal display panel. Alternatively, display interface 310 may be separate from display interface 306. In other words, display interface 306 is the display interface for one liquid crystal display panel facing front side 302 and display interface 310 is the display interface for another liquid crystal display panel facing backside 304.

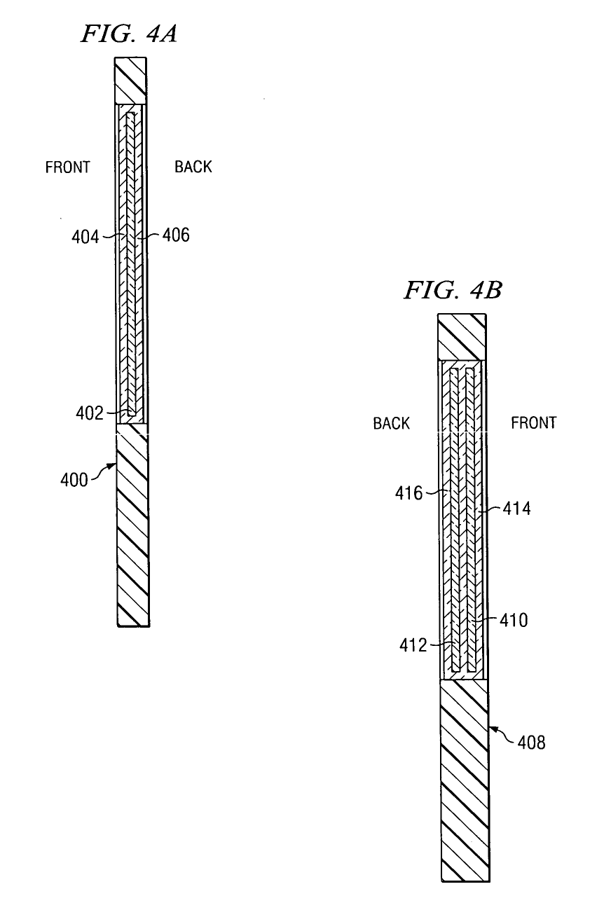

With reference now to FIG. 4A, a side view of a portable data processing system containing a single reversible liquid crystal display panel is depicted in accordance with an embodiment of the present invention. Portable data processing system 400 may be, for example, portable data processing system 300 in FIG. 3. Portable data processing system 400 may include reversible liquid crystal display panel 402. Reversible means that data may be displayed on both sides of liquid crystal display panel 402.

Reversible liquid crystal display panel 402 contains display interface 404, such as, for example, display interface 306 in FIG. 3, and display interface 406, such as, for example, display interface 310 in FIG. 3. A user may view display interface 404 from the front side, such as, for example, front side 302 in FIG. 3, of portable data processing system 400. Similarly, a user may view display interface 406 from the backside, such as, for example, backside 304 in FIG. 3, of portable data processing system 400. Display interfaces 404 and 406 also may include touch screen capabilities.

Referring now to FIG. 4B, a side view of a portable data processing system containing two back-to-back liquid crystal display panels is shown in accordance with an embodiment of the present invention. Portable data processing system 408 may be, for example, portable data processing system 300 in FIG. 3. Portable data processing system 408 may include liquid crystal display panel 410 and liquid crystal display panel 412.

Liquid crystal display panels 410 and 412 may be positioned in a “back-to-back” orientation. Consequently, a user may view display interface 414, such as, for example, display interface 306 in FIG. 3, of liquid crystal display panel 410 from the front side, such as, for example, front side 302 in FIG. 3, of portable data processing system 408. Similarly, a user may view display interface 416, such as, for example, display interface 310 in FIG. 3, of liquid crystal display panel 412 from the backside, such as, for example, backside 304 in FIG. 3, of portable data processing system 408. Display interfaces 414 and 416 also may include touch screen capabilities.

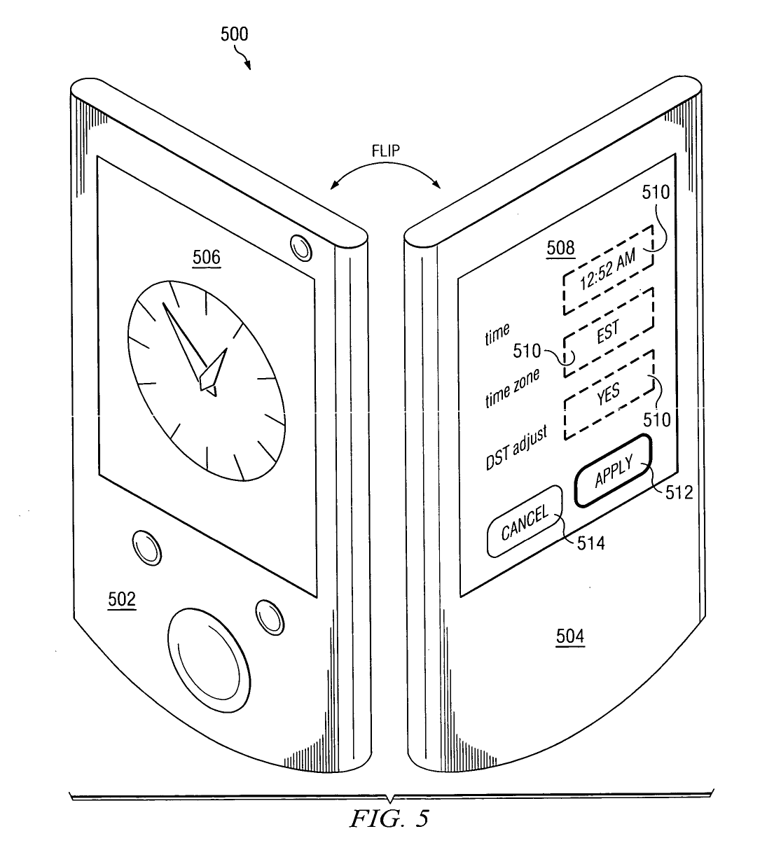

Turning now to FIG. 5, an exemplary illustration of a portable data processing system displaying an active time clock application is shown in accordance with an embodiment of the present invention. Portable data processing system 500 may be, for example, PDA 100 in FIG. 1. Portable data processing system 500 includes front side 502 and backside 504, such as front side 302 and backside 304 of portable data processing system 300 in FIG. 3.

Front side 502 contains display interface 506, which may include touch screen capabilities. In this exemplary illustration, display interface 506 displays an active time clock application that reads 12:52. Even though display interface 506 shows an analog time clock, embodiments of the present invention are not restricted to such. For example, a digital time clock or any other type of time device may be used to display time within display interface 506. Furthermore, embodiments of the present invention are not limited to applications that display time. Any software application or program capable of being implemented by embodiments of the present invention may be utilized.

A user flips or turns over portable data processing system 500 from front side 502 to backside 504 to reveal display interface 508. Display interface 508 may include touch screen capabilities as well. Portable data processing system 500 uses a flip sensor, such as flip sensor 220 in FIG. 2, to determine the position of portable data processing system 500. For example, the flip sensor detects which side of portable data processing system 500 is face up. After determining that backside 504 is now in an upward position, the flip sensor may, for example, direct the display adapter, such as display adapter 222 in FIG. 2, to activate display interface 508. Conversely, the flip sensor may direct the display adapter used above or another display adapter, such as display adapter 208 in FIG. 2, to deactivate display interface 506 while in a downward position. Deactivation of display interface 506 while in a downward position may, for example, conserve power for portable data processing system 500 or prevent translucency problems for display interface 508 if portable data processing system 500 employs a reversible liquid crystal display panel.

In addition, in response to a user input, such as a flip of portable data processing system 500, the flip sensor may, for example, direct the active application or program to render a different screen image in display interface 508. In this illustration, after the user flips portable data processing system 500 from front side 502 to backside 504, a time setting window appears in display interface 508. The time setting window may be utilized, for example, to set or change the time setting on the clock displayed in display interface 506.

The time setting window within display interface 508 may, for example, include drop-down menus 510. Drop-down menus 510 may be used, for example, to set time, time zone, and automatic adjustment for daylight savings time. Of course, the time setting window may include more or fewer drop-down menus and may include the same or different drop-down menu options. In addition, embodiments of the present invention are not restricted to the use of drop-down menus. Any menu or option selection mechanism may be utilized by embodiments of the present invention, such as, for example, radio buttons or check boxes. The user may select drop-down menus 510 and options contained within drop-down menus 510 by employing user inputs. The user inputs may be, for example, a combination of flips and/or tilts of portable data processing system 500.

Alternatively, the user may tap with a stylus, such as stylus 104 in FIG. 1, on display interface 508 to select the desired settings.

The time setting window also may include, for example, apply button 512 and cancel button 514. However, it should be noted that embodiments of the present invention are not limited to the use of an apply and/or cancel button. Any number and type of virtual buttons may be implemented by embodiments of the present invention. The user may employ cancel button 514 to cancel any settings selected in an active application or program. In addition, the user may utilize apply button 512, for example, to apply, set, enable, or execute any settings selected by the user in the active application or program. For example, in this illustration, the user selects apply button 512 to set the time at 12:52 a.m. Eastern Standard Time and to enable an automatic daylight savings time adjustment. Further, apply button 512 may be the default setting for all applications and programs using embodiments of the present invention. Consequently, when the user flips portable data processing system 500 apply button 512 executes or enables any setting within the application window.

After selecting the desired settings in the time setting window, the user flips portable data processing system 500 from backside 504 to front side 502 to reveal display interface 506 once again. The flip sensor detecting the flip of portable data processing system 500, directs the active application to automatically execute the settings specified in display interface 508 because apply button 512 is the default setting. As a result, a user using embodiments of the present invention is not required to manually select apply button 512. Thus, embodiments of the present invention increase user friendliness of portable data processing system 500 and reduce user effort by decreasing the number of steps or actions required.

In addition to directing the application to automatically execute the settings specified in display interface 508, the flip sensor also directs a display adapter or a combination of display adapters to activate display interface 506 and deactivate display interface 508. In this exemplary illustration, display interface 506 once again displays the time of 12:52, which is the applied settings from the time setting window. It should be appreciated by those of ordinary skill in the art that display interfaces 506 and 508 may simultaneously or independently display the same image or different data at the same or different times.

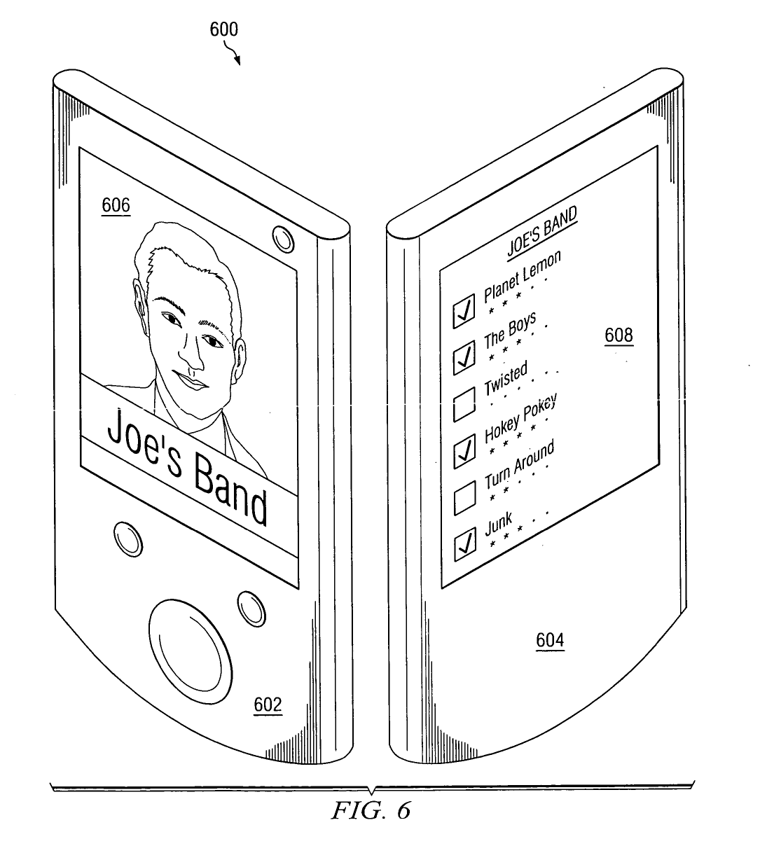

With reference now to FIG. 6, an exemplary illustration of a portable data processing system displaying a record album cover or compact disc case graphic is shown in accordance with an embodiment of the present invention. Portable data processing system 600 may be, for example, a digital music player, such as an MP3 player or iPod®. Portable data processing system 600 includes front side 602 and backside 604, such as front side 302 and backside 304 of portable data processing system 300 in FIG. 3.

Front side 602 contains display interface 606, which may include touch screen capabilities. In this exemplary illustration, display interface 606 displays a graphic resembling a record album cover or compact disc case. Even though display interface 606 depicts a record album cover or compact disc case, embodiments of the present invention are not restricted to such. Portable data processing system 600 may display any image within display interface 606.

A user flips portable data processing system 600 from front side 602 to backside 604 to reveal display interface 608, which also may include touch screen capabilities. Portable data processing system 600 utilizes the same flip sensor technology and capabilities as portable data processing system 500 in FIG. 5. As a result, a flip sensor, such as flip sensor 220 in FIG. 2, detects that backside 604 is now in an upward position. Further, the flip sensor may direct a display adapter, such as display adapter 222 in FIG. 2, to activate display interface 608. Similarly, the flip sensor may direct the same or a different display adapter, such as display adapter 208 in FIG. 2, to deactivate display interface 606. Deactivation of display interface 606 may conserve power and prevent translucency problems.

In addition, the flip sensor may direct the active application to render a different screen image in display interface 608. In this illustration, display interface 608 displays artist name, title, list of song selections, and ratings. However, embodiments of the present invention are not limited to the items listed above for display within display interface 608. Any textual or graphic information may be displayed by embodiments of the present invention within display interface 608.

The user selects a song or songs by, for example, employing a series of flips and/or tilts of portable data processing system 600 or tapping with a stylus, such as stylus 104 in FIG. 1, on display interface 608 to check the appropriate box or boxes in the song list. However, embodiments of the present invention are not restricted to check box option selection as shown in this example. Any option selection mechanism may be employed by embodiments of the present invention, such as, for example, radio buttons or drop-down menus.

After the user selects the desired songs within display interface 608, the user flips over portable data processing system 600 to reveal display interface 606. The flip sensor detects the flip and directs the active application to automatically execute the song selections specified in display interface 608 because embodiments of the present invention use a default apply setting. In addition, the flip sensor directs a display adapter or combination of display adapters to activate display interface 606 and deactivate display interface 608. In this exemplary illustration, display interface 606 again displays the graphic resembling the record album cover or compact disc case. However, display interface 606 may alternatively show, for example, the name of the song currently playing, elapsed time, background graphics, colors, pictures or any combination thereof while the song is playing.

Moreover, the flip sensor may include a speed detection mechanism, such as, for example, an accelerometer. The speed detection mechanism detects the speed of the flipping motion employed by the user on portable data processing system 600. The flip sensor may use the speed detection mechanism to direct the active application to execute certain functions during, for example, a “quick” flipping or tilting motion of portable data processing system 600. The flip sensor may use the speed detection mechanism to execute functions, such as fast forward, reverse, skip to next song, replay song, and the like. However, embodiments of the present invention are not limited to the above list of functions associated with a quick flipping or tilting motion of portable data processing system 600. The speed detection mechanism may be utilized to execute any function implemented by embodiments of the present invention.

In addition to detecting the speed of the flip, the flip sensor determines direction of the flip. Consequently, the flip sensor may execute, for example, fast forward or skip to next song during a quick clockwise flip of portable data processing system 600 and reverse or replay song during a quick counterclockwise flip of portable data processing system 600. It should be appreciated by those of ordinary skill in the art that any application or program function may be associated with direction and speed of a flip, tilt, or combination of flips and/or tilts of portable data processing system 600. Further, it should be appreciated by those of ordinary skill in the art that the flip sensor may be calibrated to detect, for example, a 10, 25, 45, or 90 degree pitch or tilt of portable data processing system 600. However, the list of degree increments above is only exemplary and not meant as a restriction or limitation on embodiments of the present invention. Embodiments of the present invention may calibrate the flip sensor to any degree increment necessary.

Furthermore, it should be appreciated by those of ordinary skill in the art that in addition to detecting horizontal orientation of portable data processing system 600, the flip sensor may detect vertical orientation as well, along with any degree of orientation between horizontal and vertical. As an illustration, if the user points the top edge of portable data processing system 600 toward the ground, the flip sensor may, for example, execute a pause function. Similarly, if the user points the top edge of portable data processing system 600 toward the sky, the flip sensor may direct, for example, the active application or program to close. Of course, any predetermined portable data processing system orientation may be used as a user input to execute any application or program function in accordance with embodiments of the present invention.

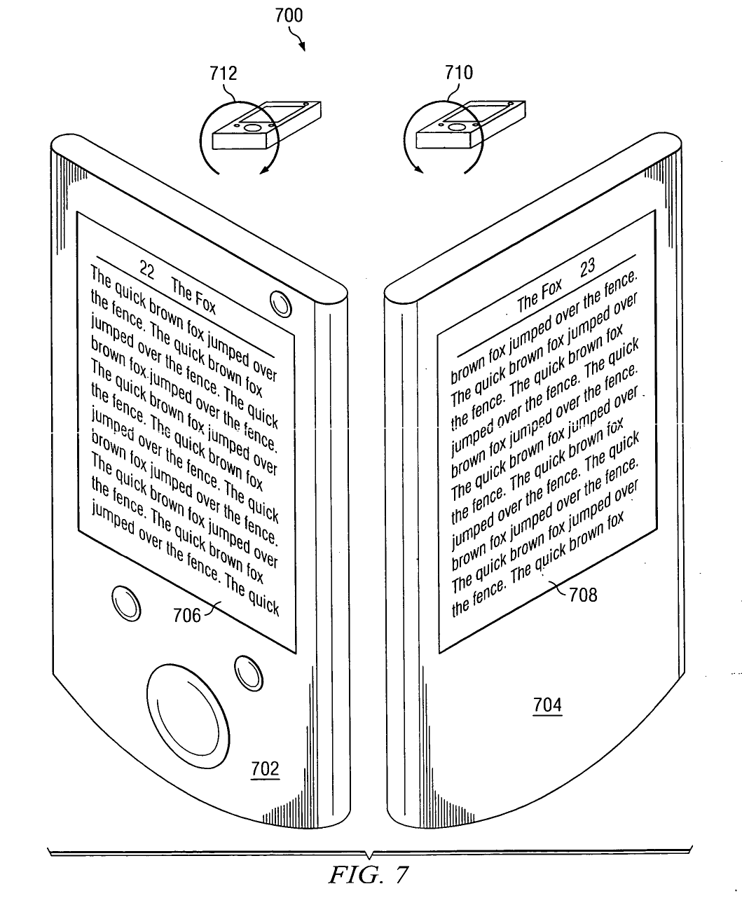

Referring now to FIG. 7, an exemplary illustration of a portable data processing system displaying an electronic book is depicted in accordance with an embodiment of the present invention. Portable data processing system 700 may be, for example, a PDA, such as PDA 100 in FIG. 1. Portable data processing system 700 includes front side 702 and backside 704, such as front side 302 and backside 304 of portable data processing system 300 in FIG. 3.

Front side 702 contains display interface 706, which may include touch screen capabilities. In this exemplary illustration, display interface 706 displays page 22 of the electronic book. Even though display interface 706 displays an electronic book, embodiments of the present invention are not limited to such. Display interface 706 may display any image associated with any active application or program implemented by embodiments of the present invention.

A user flips portable data processing system 700 to reveal display interface 708. Display interface 708 also may include touch screen capabilities. Portable data processing system 700 utilizes the same flip sensor technology and capabilities as portable data processing systems 500 in FIG. 5 and 600 in FIG. 6. Therefore, when the user flips portable data processing system 700 the flip sensor directs the display adapter, such as display adapter 222 in FIG. 2, to activate display interface 708. Similarly, the flip sensor directs the same or a different display adapter, such as display adapter 208 in FIG. 2, to deactivate display interface 706.

In this illustrated example, the user employs counterclockwise flip 710 on portable data processing system 700 to page forward the electronic book. As a result, display interface 708 displays page 23 of the electronic book. If the user employs counterclockwise flip 710 once again, then display interface 706 will display page 24 of the electronic book. If the user employs counterclockwise flip 710 one more time, display interface 708 will display page 25 of the electronic book and so on.

Conversely, the user employs clockwise flip 712 to page backward in the electronic book. Consequently, if the user employs clockwise flip 712 from the illustrated starting point of page 22 within display interface 706, then display interface 708 will display page 21 of the electronic book. If the user employs clockwise flip 712 once more, then display interface 706 will display page 20 and so on.

Thus, embodiments of the present invention do not require the user to manually press forward or backward function buttons, such as function buttons 308 in FIG. 3, to page forward or backward within the electronic book. Embodiments of the present invention only require the user to change the orientation of portable data processing system 700 by a predetermined amount, such as a 180 degree flip, in order to view a different page, which is much like naturally turning a page in a book. In addition, a quick counterclockwise flip may, for example, advance the electronic book several predetermined pages, to the next chapter, or to the end of the book. Similarly, a quick clockwise flip may, for example, turn back the book several predetermined pages, to the previous chapter, or to the beginning of the book.

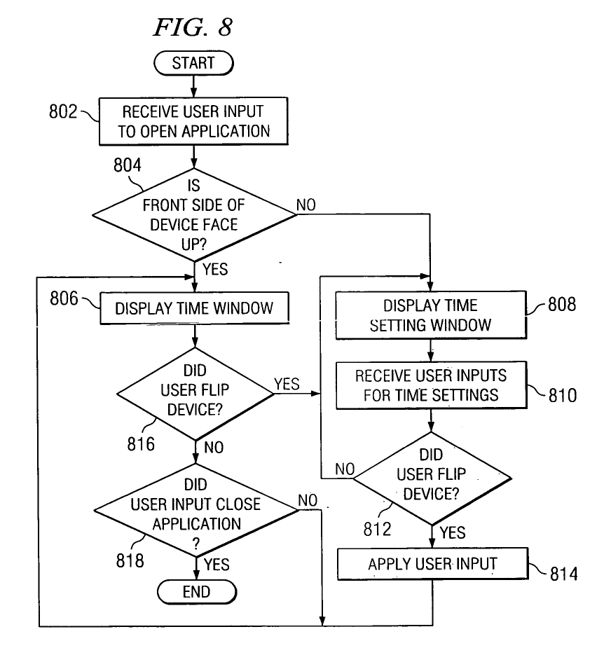

Turning now to FIG. 8, a flowchart illustrating an exemplary process for displaying a time application within a portable data processing system with a plurality of display interfaces is depicted in accordance with an embodiment of the present invention. The process depicted in FIG. 8 may be implemented, for example, in a portable data processing system, such as portable data processing system 500 in FIG. 5.

The process begins when a user utilizes a user input to open an application that displays time within the portable data processing system (step 802). However, it should be noted that the use of a time application in this example is for illustrative purposes only and not intended as a restriction or limitation on embodiments of the present invention. Any application or program capable of being implemented by embodiments of the present invention may be used. Subsequent to the user opening the time application in step 802, a determination is made as to whether the front side of the portable data processing system, such as front side 502 in FIG. 5, is face up (step 804). The portable data processing system employs a flip sensor, such as flip sensor 220 in FIG. 2, to detect the orientation of the portable data processing system.

If the front side of the portable data processing system is face up, yes output of step 804, then the portable data processing system displays a time window within the display interface, such as display interface 506 in FIG. 5 (step 806). The portable data processing system utilizes a display adapter, such as display adapter 208 in FIG. 2, to control the data displayed within the front side display interface. Further, the front side display interface may have touch screen capabilities.

If the front side of the portable data processing system is not face up, no output of step 804, then the portable data processing system displays a time setting window within the backside display interface, such as display interface 508 of backside 504 in FIG. 5 (step 808). The portable data processing system may use the same display adapter or a different display adapter, such as display adapter 222 in FIG. 2, to control the data displayed within the backside display interface. Further, the backside display interface also may include touch screen capabilities.

After the portable data processing system displays the time setting window within the backside display interface in step 808, the portable data processing system may receive user time setting inputs from, for example, drop-down menus, such as drop-down menus 510 in FIG. 5, to set or change the time within the active time application (step 810). Then a determination is made as to whether the user flips the portable data processing system (step 812). If the user does not flip the portable data processing system, no output of step 812, then the process returns to step 808 where the portable data processing system continues to display the time setting window. If the user does flip the portable data processing system, yes output of step 812, then the portable data processing system applies the user inputs inputted in step 810 because of the default apply setting, such as default apply setting or button 512 in FIG. 5 (step 814).

Subsequent to the portable data processing system applying the user inputs in step 814, the process returns to step 806. After the portable data processing system displays the time window in step 806, a determination is made as to whether the user flips the portable data processing system (step 816). If the user does flip the portable data processing system, yes output of step 816, then the process returns to step 808 where the portable data processing system displays the time setting window. It should be noted that if the time window in this exemplary illustration included option or function settings, the flipping motion performed in step 816 would automatically execute or enable the option or function settings due to the default apply setting.

If the user does not flip the portable data processing system, no output of step 816, then a determination is made as to whether user employs a user input to close the time application (step 818). The user input may be, for example, a predetermined user flip or tilt of the portable data processing system, a tap with a stylus on a virtual close button contained within the display interface, or a manual pressure on a close function button contained on the front side of the portable data processing system. If the user does not employ a user input to close the time application, no output of step 818, then the process returns to step 806 where the portable data processing system continues to display the time window. If the user does employ a user input to close the time application, yes output of step 818, then the process terminates thereafter.

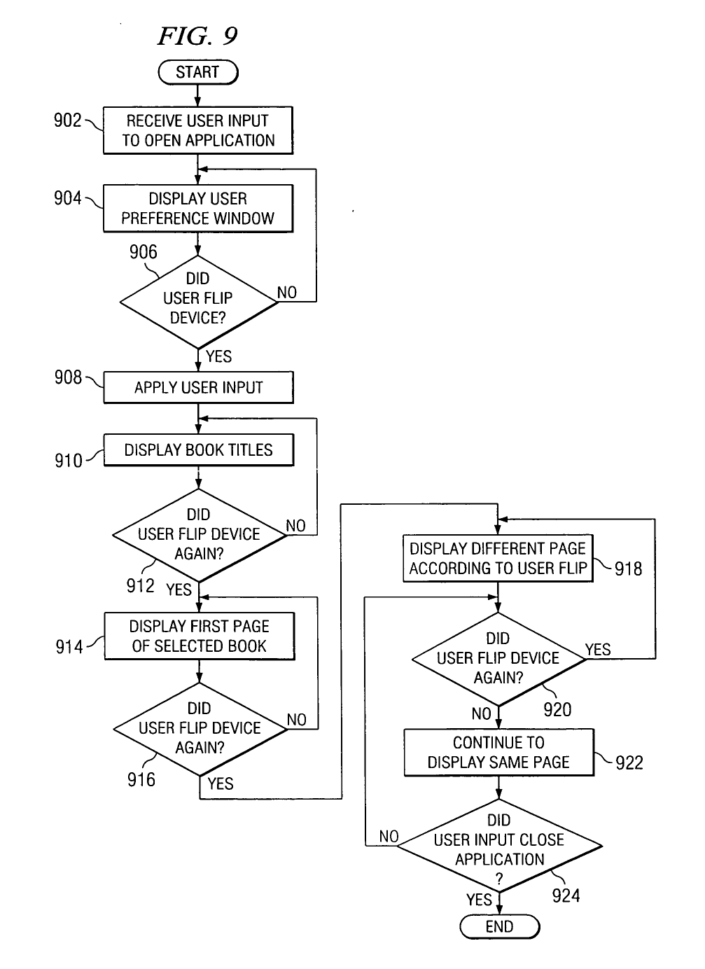

With reference now to FIG. 9, a flowchart illustrating an exemplary process for displaying an electronic book application within a portable data processing system with a plurality of display interfaces is shown in accordance with an embodiment of the present invention. The process shown in FIG. 9 may be implemented, for example, in a portable data processing system, such as portable data processing system 700 in FIG. 7.

The process begins when a user utilizes a user input to open an electronic book application within the portable data processing system (step 902). The user input may be, for example, a predetermined user flip or tilt of the portable data processing system, a tap with a stylus on a virtual open button contained within the display interface, or a manual pressure on an open function button contained on the front side of the portable data processing system. Subsequent to receiving the user input to open the electronic book application in step 902, the portable data processing system may, for example, display a user preference window within the display interface of the front side of the portable data processing system, such as display interface 706 of front side 702 in FIG. 7 (step 904). The portable data processing system utilizes a display adapter, such as display adapter 208 in FIG. 2, to control the data displayed within the front side display interface. Further, the front side display interface may have touch screen capabilities.

Alternatively, the user preference window may, for example, only appear the first time the user opens electronic book application on the portable data processing system or when the user selects preferences within, for example, a tools or options menu within the electronic book application. The user may utilize the user preference window to input how the user wishes to view the electronic book, such as, for example, font size, font color, font style, background color, starting page, and the like. It should be noted that if the user preference window does not appear after step 902, the process may proceed to step 910.

Subsequent to the user inputting user preferences into the user preference window in step 904, a determination is made as to whether the user flips the portable data processing system (step 906). The portable data processing system uses a flip sensor, such as flip sensor 220 in FIG. 2, to detect the user flip and to direct the portable data processing system to enable or execute any settings within the active application window. If the user does not flip the portable data processing system, no output of step 906, then the process returns to step 904 where the portable data processing system continues to display the user preference window. If the user does flip the portable data processing system, yes output of step 906, then the portable data processing system applies the user inputs within the user preference window because of the default apply setting (step 908).

After applying the user inputs in step 908, the portable data processing system may, for example, display all book titles contained in the electronic book application (step 910). The portable data processing system displays the book titles in the backside display interface, such as, for example, display interface 708 on backside 704. The portable data processing system may use the same or a different display adapter, such as display adapter 222 in FIG. 2, to control the data displayed within the backside display interface. Further, the backside display interface also may include touch screen capabilities.

While viewing the titles contained in the electronic book application, the user may, for example, tilt the portable data processing system 45 degrees in any direction to navigate between book titles. However, the 45 degree tilt to perform the navigation function is only exemplary and is not intended as a limitation on embodiments of the present invention. Any degree of user tilt, flip, or combination of thereof may be implemented by embodiments of the present invention. Alternatively, the user may utilize, for example, a stylus, such as stylus 104 in FIG. 1, to input title preference.

Then a determination is made as to whether the user flips the portable data processing system again (step 912). If the user does not flip the portable data processing system, no output of step 912, then the process returns to step 910 where the portable data processing system continues to display the book titles. If the user does flip the portable data processing system, yes output of step 912, then the portable data processing system executes the user book title selection and displays the first page of the selected book in the front side display interface (step 914).

Subsequent to displaying the first page of the selected book in step 914, then a determination is made as to whether the user flips the portable data processing system again (step 916). If the user does not flip the portable data processing system again, no output of step 916, then the process returns to step 914 where the portable data processing system continues to display the first page of the selected book. If the user does flip the portable data processing system again, yes output of step 916, then the portable data processing system displays a different page according to the direction of the user flip (step 918).

Therefore, if the user utilizes a counterclockwise flip, such as counterclockwise flip 710 in FIG. 7, then the portable data processing system displays the next page in the electronic book within the backside display interface, which is page 2 in this example. If the user employs, for example, a clockwise flip, such as clockwise flip 712 in FIG. 7, then the portable data processing system displays the previous page in the electronic book within the backside display interface, which in this illustration may be the book titles page.

Then a determination is made as to whether the user flips the portable data processing system again (step 920). If the user does flip the portable data processing system again, yes output of step 920, then the process returns to step 918 where the portable data processing system displays a different page according to the direction of the user flip as described above. For example, if the user uses a counterclockwise flip while viewing page 2 in the backside display interface, then the portable data processing system displays page 3 in the front side display interface. Similarly, if the user uses a clockwise flip while viewing page 2 in the backside display interface, then the portable data processing system displays page 1 in the front side display interface. The user may continue the flipping process ad infinitum to view every or any page within the electronic book. In addition, the user may employ, for example, a series or combination of flips or tilts to advance or retreat the electronic book a predetermined amount of pages, to a next or previous chapter, or to the beginning or ending of the electronic book.

If the user does not flip the portable data processing system again, no output of step 920, then the portable data processing system continues to display the same page (step 922). Then a determination is made as to whether the user employs a user input to close the electronic book application (step 924). If the user does not employ a user input to close the electronic book application, no output of step 924, then the process returns to step 920 where the portable data processing system determines whether the user flips the portable data processing system once more. If the user does employ a user input to close the electronic book application, yes output of step 924, then the process terminates thereafter.

Thus, embodiments of the present invention provide a computer implemented method, data processing system, and computer useable program code for displaying data in a portable data processing system with a plurality of display interfaces. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), and digital video disc (DVD).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for displaying data in a portable data processing system with a plurality of display interfaces, the computer implemented method comprising:
displaying data within a first display interface of the portable data processing system;
detecting a user input, wherein the user input is a change in an orientation of the portable data processing system;
determining a type of change in the orientation of the portable data processing system; and
responsive to determining the type of change in the orientation of the portable data processing system, displaying the data within the first display interface or a second display interface of the portable data processing system based upon the type of change in the orientation.

2. The computer implemented method of claim 1, wherein the data displayed within the first display interface is a first portion of data, and wherein a second portion of data is displayed in the first or second display interface in response to determining the type of change in the orientation of the portable data processing system.

3. The computer implemented method of claim 1, further comprising:
responsive to determining the type of change in the orientation of the portable data processing system, performing a task within an active application.

4. The computer implemented method of claim 3, wherein the type of change in the orientation of the portable data processing system is at least one of a flip, tilt, flip or tilt speed, flip or tilt direction, or flip or tilt speed and direction.

5. The computer implemented method of claim 1, wherein the first display interface is on a first side of the portable data processing system and the second display interface is on a second side of the portable data processing system.

6. The computer implemented method of claim 1, wherein the first display interface and the second display interface display different data at different times.

7. The computer implemented method of claim 1, wherein the first display interface and the second display interface display different data at a same time.

8. The computer implemented method of claim 1, wherein the first display interface and the second display interface display a same data at a same time.

9. The computer implemented method of claim 1, wherein the detecting and determining steps are performed by a flip sensor.

10. The computer implemented method of claim 9, wherein the flip sensor is at least one of a gyroscope or mercury switches.

11. The computer implemented method of claim 3, wherein the task is at least one of a navigation function or a default apply function.

12. The computer implemented method of claim 4, wherein a counterclockwise flip direction executes a forward pagination within a multiple page document application and a clockwise flip direction executes a backward pagination within the multiple page document application.

13. The computer implemented method of claim 1, wherein the portable data processing system is at least one of a digital personal assistant, palmtop computer, laptop computer, cellular telephone, or digitized music player.

14. A data processing system comprising:
a bus system;
a storage device connected to the bus system, wherein the storage device includes a set of instructions; and
a processing unit connected to the bus system, wherein the processing unit executes the set of instructions to display data within a first display interface of the portable data processing system; detect a user input, wherein the user input is a change in an orientation of the portable data processing system; determine a type of change in the orientation of the portable data processing system; and display the data within the first display interface or a second display interface of the portable data processing system based upon the type of change in the orientation in response to determining the type of change in the orientation of the portable data processing system.

15. The data processing system of claim 14, wherein the first display interface is on a first side of the portable data processing system and the second display interface is on a second side of the portable data processing system.

16. The data processing system of claim 14, wherein detecting the user input and determining the type of change in the orientation of the portable data processing system is performed by a flip sensor.

17. A computer program product for displaying data in a portable data processing system with a plurality of display interfaces, the computer program product comprising:
a computer usable medium having computer usable program code embodied therein, the computer usable medium comprising:
computer usable program code configured to display data within a first display interface of the portable data processing system;
computer usable program code configured to detect a user input, wherein the user input is a change in an orientation of the portable data processing system;
computer usable program code configured to determine a type of change in the orientation of the portable data processing system; and
computer usable program code configured to display the data within the first display interface or a second display interface of the portable data processing system based upon the type of change in the orientation in response to determining the type of change in the orientation of the portable data processing system.

18. The computer program product of claim 17, further comprising:
computer usable program code configured to perform a task within an active application in response to determining the type of change in the orientation of the portable data processing system.

19. The computer program product of claim 17, wherein the type of change in orientation of the portable data processing system is at least one of a flip, tilt, flip or tilt speed, flip or tilt direction, or flip or tilt speed and direction.

20. The computer program product of claim 18, wherein the task is at least one of a navigation function or a default apply function.
